(19) United States
(12) Patent Application Publication
(10) Pub. No.: US 2019/0006702 A1
(43) Pub. Date: Jan. 3, 2019

(54) SOLID-STATE ELECTROLYTE AND ALL-SOLID-STATE BATTERY

(71) Applicant: Murata Manufacturing Co., Ltd., Nagaokakyo-shi (JP)

(72) Inventors: Makoto Yoshioka, Nagaokakyo-shi (JP); Akisuke Ito, Nagaokakyo-shi (JP); Ryohei Takano, Nagaokakyo-shi (JP); Takeo Ishikura, Nagaokakyo-shi (JP)

(21) Appl. No.: 16/121,805

(22) Filed: Sep. 5, 2018

Related U.S. Application Data
(63) Continuation of application No. PCT/JP2017/004061, filed on Feb. 3, 2017.

(30) Foreign Application Priority Data
Apr. 19, 2016 (JP) 2016-083862

(51) Int. Cl. H01M 10/056; H01M 10/04; H01M 4/02

(52) U.S. Cl. CPC H01M 10/056; H01M 10/045; H01M 2004/028; H01M 2004/027; H01M 4/02

(57) ABSTRACT

A solid-state electrolyte having a NaSICON-type crystal structure represented by a general formula Li_{1+X}M_{y}(PO₄)₃, in which a part of P may be substituted by at least one selected from the group consisting of Si, B, and V; M includes at least one element selected from a monovalent cation to a tetravalent cation, x is −0.200 to 0.900, and y is 2.001 to 2.200.

### CROSS REFERENCE TO RELATED APPLICATIONS

The present application is a continuation of International application No. PCT/JP2017/004061, filed Feb. 3, 2017, which claims priority to Japanese Patent Application No. 2016-083862, filed Apr. 19, 2016, the entire contents of each of which are incorporated herein by reference.

### FIELD OF THE INVENTION

The present invention relates to a solid-state electrolyte and an all-solid-state battery.

### BACKGROUND OF THE INVENTION

Conventionally, all-solid-state batteries have been known as secondary batteries having excellent reliability and safety. For example, Patent Documents 1 and 2 describe an all-solid-state battery having a solid-state electrolyte made of a phosphate compound having a NaSICON structure. In addition, Patent Document 3 describes a solid-state electrolyte material represented by Chemical formula LiₓM1_{y}M2_{z}Zr₂₋ₓ(PO₄)₃ (in which M1 includes at least one selected from Ti, Ge, and Zr, and M2 includes at least one selected from Mg, Ca, Ba, Al, Cr, In, Sc, Y, and Hf).

Patent Document 1: Japanese Patent Application Laid-Open No. 2007-258148

Patent Document 2: Japanese Patent Application Laid-Open No. 2001-143754

Patent Document 3: Japanese Patent Application Laid-Open No. 2015-065021

### SUMMARY OF THE INVENTION

There is a demand for an all-solid-state battery to improve the ionic conductivity of the solid-state electrolyte layer and to improve the battery characteristics of the all-solid-state battery.

A main object of the present invention is to improve the ionic conductivity of the solid-state electrolyte layer and to improve the battery characteristics of the all-solid-state battery.

The solid-state electrolyte according to the present invention has a NaSICON-type crystal structure represented by a general formula Li_{1+X}M_{y}(PO₄)₃. In the formula, a part of P may be substituted by at least one selected from the group consisting of Si, B, and V, M includes at least one element that is a monovalent cation to a tetravalent cation, x is −0.200 to 0.900, and y is 2.001 to 2.200.

In the solid-state electrolyte in which Li is the ionic conduction species, the ion conduction path is constituted by the Li site. Therefore, it is considered that when the Li site is substituted by another element other than the ionic conduction species, the ionic conductivity decreases. In the solid-state electrolyte represented by the general formula Li_{1+X}M_{y}(PO₄)₃, when y is larger than 2, (y−2) pieces of Ms are considered to be located at the Li site. Therefore, it is considered that when y is larger than 2, the ionic conductivity of the solid-state electrolyte decreases. However, as a result of intensive research, the present inventors have found that, when M includes at least one element that is a monovalent cation to a tetravalent cation and y is 2.001 to 2.200, the ionic conductivity of the solid-state electrolyte can be improved as compared to when y is 2. Accordingly, the inventors have completed the present invention. That is, in the solid-state electrolyte according to the present invention, M includes at least one element that is a monovalent cation to a tetravalent cation and y is 2.001 to 2.200. Therefore, the solid-state electrolyte according to the present invention has high ion conductivity.

In the solid-state electrolyte according to the present invention, it is preferable that y is 2.001 to 2.100.

In the solid-state electrolyte according to the present invention, it is more preferable that y is 2.001 to 2.050.

In the solid-state electrolyte according to the present invention, it is preferable that M includes at least one element that is a monovalent cation to a trivalent cation.

In the solid-state electrolyte according to the present invention, it is preferable that M includes at least one element selected from the group consisting of Zr, Hf, Ca, Y, Na, Al, Ga, Sc, V, In, Ti, Ge, and Sn.

In the solid-state electrolyte according to the present invention, it is preferable that M includes at least one element selected from the group consisting of Na, Ca, Y, Al, Ga, Sc, V, and In.

In the solid-state electrolyte according to the present invention, it is preferable that M includes at least one element selected from the group consisting of Zr, Hf, Sn, Ti, and Ge.

An all-solid-state battery according to the present invention includes a solid-state electrolyte which includes the solid-state electrolyte according to the present invention described herein; a positive electrode joined to a first surface of the solid-state electrolyte layer; and a negative electrode joined to a second surface of the solid-state electrolyte.

According to the present invention, it is possible to improve the ionic conductivity of the solid-state electrolyte layer and to improve the battery characteristics of the all-solid-state battery.

### BRIEF EXPLANATION OF THE DRAWINGS

FIG. 1 is a schematic cross-sectional view of an all-solid-state battery according to an embodiment of the present invention.

FIG. 2 is a Cole-Cole plot of the solid-state electrolyte produced in Example 1.

FIG. 3 is a Cole-Cole plot of the solid-state electrolyte produced in Comparative Example 1.

### DETAILED DESCRIPTION OF THE INVENTION

Hereinafter, an example of preferred embodiments of the present invention will be described. However, the following embodiments are merely examples and the present invention is limited only by the claims.

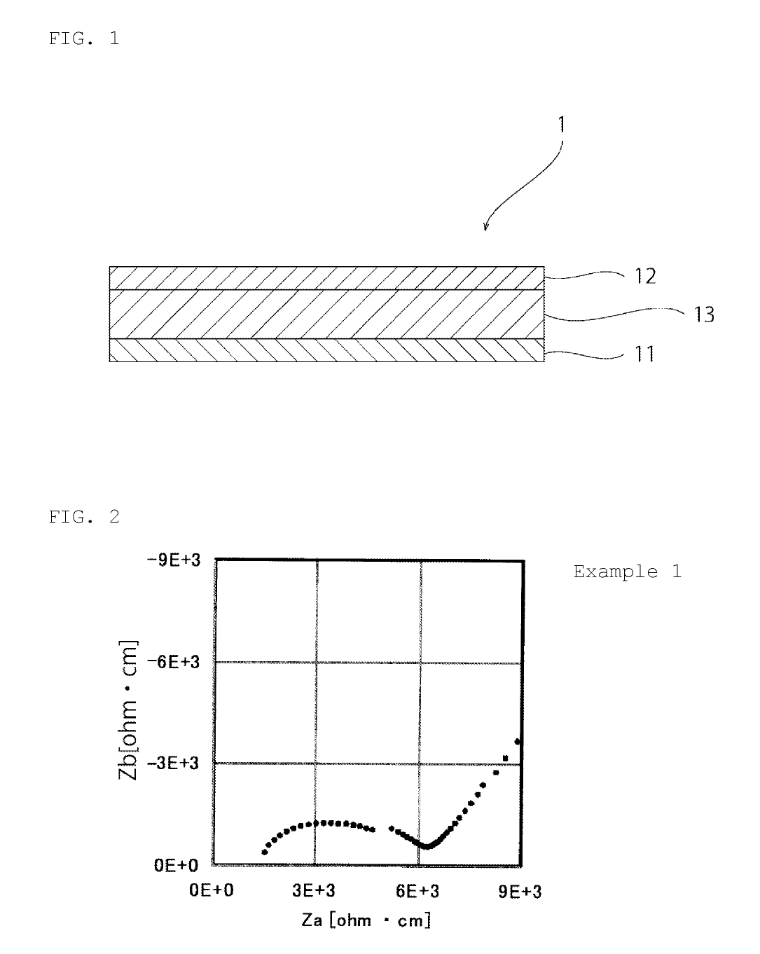

FIG. 1 is a schematic cross-sectional view of an all-solid-state battery 1 according to this embodiment. As shown in FIG. 1, the battery includes a positive electrode 11, a negative electrode 12, and a solid-state electrolyte layer 13.

The positive electrode 11 includes positive electrode active material particles. Examples of the positive electrode active material particles to be preferably used include lithium-containing phosphate compound particles having a NaSICON-type structure, lithium-containing phosphate compound particles having an olivine-type structure, lithium-containing layered oxide particles, and lithium-containing oxide particles having a spinel-type structure. Specific examples of the lithium-containing phosphate compound having a NaSICON-type structure to be preferably used include Li₃V₂ (PO₄)₃. Specific examples of the lithium-containing phosphate compound having an olivine-type structure to be preferably used include LiFe(PO₄) and LiMnPO₄. Specific examples of the lithium-containing layered oxide particles to be preferably used include LiCoO₂ and LiCo_{1/3}Ni_{1/3}Mn_{1/3}O₂. Specific examples of the lithium-containing oxide having a spinel-type structure to be preferably used include LiMn₂O₄ and LiNi_{0.5}Mn_{1.5}O₄. Only one kind of these positive electrode active material particles may be used, or a plurality of kinds thereof may be mixed and used.

The positive electrode 11 may further include a solid-state electrolyte. The kind of solid-state electrolyte included in the positive electrode 11 is not particularly limited, and it is preferable to include the same kind of solid-state electrolyte as the solid-state electrolyte contained in the solid-state electrolyte layer 13. In this case, the close contact between the solid-state electrolyte layer 13 and the positive electrode 11 can be improved.

The negative electrode 12 includes negative electrode active material particles. Specific examples of the negative electrode active material particles to be preferably used include compound particles represented by the formula MO_{X} (where M is at least one selected from the group consisting of Ti, Si, Sn, Cr, Fe, Nb, P, and Mo. X is 0.9 to 2.5), graphite-lithium compound particles, lithium alloy particles, lithium-containing phosphate compound particles having a NaSICON-type structure, lithium-containing phosphate compound particles having an olivine-type structure, and lithium-containing oxide particles having a spinel-type structure. Specific examples of lithium alloys to be preferably used include Li—Al alloys. Specific examples of the lithium-containing phosphate compound having a NaSICON-type structure to be preferably used include Li₃V₂ (PO₄)₃. Specific examples of the lithium-containing oxide having a spinel-type structure to be preferably used include Li₄Ti₅O₁₂. Only one kind of these negative electrode active material particles may be used, or a plurality of kinds thereof may be mixed and used.

The negative electrode 12 may further include a solid-state electrolyte. The kind of solid-state electrolyte included in the negative electrode 12 is not particularly limited, and it is preferable to include the same kind of solid-state electrolyte as the solid-state electrolyte contained in the solid-state electrolyte layer 13. In this case, the close contact between the solid-state electrolyte layer 13 and the negative electrode 12 can be improved.

The solid-state electrolyte layer 13 is disposed between the positive electrode 11 and the negative electrode 12. That is, the positive electrode 11 is disposed on one side of the solid-state electrolyte layer 13, and the negative electrode 12 is disposed on the other side thereof. Each of the positive and negative electrodes 11 and 12 is joined to the solid-state electrolyte layer 13 by sintering. In other words, the positive electrode 11, the solid-state electrolyte layer 13, and the negative electrode 12 are an integrated sintered body.

The solid-state electrolyte layer 13 includes a solid-state electrolyte having a NaSICON-type crystal structure, which is represented by the general formula Li_{1+X}M_{y}(PO₄)₃. In the general formula, a part of P may be substituted by at least one selected from the group consisting of Si, B, and V, M includes at least one element that is a monovalent cation to a tetravalent cation, x is −0.200 to 0.900, and y is 2.001 to 2.200. Thus, the solid-state electrolyte layer 13 according to this embodiment has high ionic conductivity. Therefore, the all-solid-state battery 1 having the solid-state electrolyte layer 13 is excellent in properties such as power density. Although the reason for this is not certain, it is considered due to the fact that, for example, when M includes an element which is a tetravalent cation and y is 2.001 to 2.200, a high ion conducting phase is likely to be formed by M. On the other hand, when M includes elements which are monovalent to trivalent cations and y is 2.001 to 2.200, it is considered due to the fact that a high ion conducting phase is formed and further it is possible to suppress a decrease in the amount of Li contributing to ionic conduction from the viewpoint of charge compensation.

Specific examples of preferred elements that are monovalent to trivalent cations include Na, Ca, Y, Al, Ga, Sc, V. Among them, Na and Ca are preferably used as the monovalent to trivalent cations.

Specific examples of preferred elements that are tetravalent cations include Zr, Hf, Sn, Ti, and Ge. Among them, Zr, Hf, and Sn are more preferably used as the tetravalent cations.

The M may be constituted of a single element or may be constituted of plural kinds of elements. When M is constituted of plural kinds of elements, it is preferable that M includes both elements which are monovalent to trivalent ions and an element which is a tetravalent ion. The M includes both the elements which are monovalent to trivalent ions and the element which is a tetravalent ion so that it is possible to obtain high ion conductivity. This is considered to be because the amount of Li contributing to ionic conduction can be increased.

Note that, in the general formula Li_{1+X}M_{y}(PO₄)₃, a part of P may be substituted by at least one selected from the group consisting of B, Si, and V. In that case, at least one molar ratio ((at least one selected from the group consisting of B, Si, and V)/(P)) selected from the group consisting of B, Si, and V to P relative to P is preferably 0.0 to 2.0, and more preferably 0.0 to 0.5.

The stoichiometric ratio 1+x of Li can be appropriately adjusted in a range of −0.200≤x≤0.900 in order to maintain the neutrality between the positive and negative charges in the crystal. The range of x is more preferably −0.160≤x≤0.500, and still more preferably 0.050≤x≤0.350.

Note that the compound represented by the formula Li_{1+X}M_{y}(PO₄)₃ has 12 oxygens, but regarding the number of oxygen contained in the compound represented by this formula, the stoichiometric ratio of O does not need to be strictly 12 from the viewpoint of maintaining the neutrality between the positive and negative charges. In the present invention, the compound represented by the formula Li_{1+X}M_{y}(PO₄)₃ includes compounds containing 7 mol to 15 mol of oxygen.

Hereinafter, the present invention will be described in more detail based on specific examples, however, the present invention is not limited to the following examples at all, and may be modified as appropriate without changing the gist thereof.

### Comparative Example 1

Raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the formula Li_{1+X}M_{y}(PO₄) 3 satisfying the conditions shown in Table 1 was obtained. Subsequently, the weighed raw material powders were sealed in a 500 ml polyethylene pot and rotated on a pot rack at a speed of 150 rpm for 16 hours, and the raw materials were mixed. Subsequently, the raw materials were fired in an air atmosphere at 500° C. for 1 hour and then fired at 800° C. for 6 hours to remove volatile components. Subsequently, the obtained fired product was sealed in a 500 ml polyethylene pot together with water and cp 5 mm cobblestones, and rotated on a pot rack at a speed of 150 rpm for 16 hours, thereby grinding the fired product. Thereafter, the ground product was placed on a hot plate at 120° C. and heated to remove moisture. The obtained ground product was fired in an air atmosphere at 900° C. to 1200° C. for 20 hours to obtain a solid-state electrolyte powder having the composition of Comparative Example 1 shown in Table 1 below.

### Example 1

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 2

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 3

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 4

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 5

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 6

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 7

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Example 8

A solid-state electrolyte powder was obtained in the same manner as in Comparative Example 1 except that raw materials such as lithium carbonate (Li₂CO₃), zirconium oxide (ZrO₂), ammonium dihydrogen phosphate (NH₄H₂PO₄), calcium oxide (CaO), yttrium oxide (Y₂O₃), and yttrium stabilized zirconia were weighed so that the composition was such that the general formula Li_{1+X}M_{y}(PO₄)₃ satisfying the conditions shown in Table 1 was obtained.

### Comparative Example 2

A solid-state electrolyte powder was obtained in the same manner as in Comparative Example 1 except that raw materials including lithium carbonate (Li₂CO₃), ammonium dihydrogen phosphate (NH₄H₂PO₄), calcium oxide (CaO), yttrium oxide (Y₂O₃), and hafnium oxide (HfO₂) were weighed so that the composition was such that the general formula Li_{1+X}M_{y}(PO₄)₃ satisfying the conditions shown in Table 1 was obtained.

### Example 9

A solid-state electrolyte powder was obtained in the same manner as in Comparative Example 1 except that raw materials including lithium carbonate (Li₂CO₃), ammonium dihydrogen phosphate (NH₄H₂PO₄), calcium oxide (CaO), yttrium oxide (Y₂O₃), and hafnium oxide (HfO₂) were weighed so that the composition was such that the general formula Li_{1+X}M_{y}(PO₄)₃ satisfying the conditions shown in Table 1 was obtained.

### Comparative Example 3

A solid-state electrolyte powder was obtained in the same manner as in Comparative Example 1 except that raw materials including lithium carbonate (Li₂CO₃), ammonium dihydrogen phosphate (NH₄H₂PO₄), calcium oxide (CaO), yttrium oxide (Y₂O₃), and tin dioxide (SnO₂) were weighed so that the composition was such that the formula Li_{1+X}M_{y}(PO₄)₃ satisfying the conditions shown in Table 1 was obtained.

### Example 10

A solid-state electrolyte powder was obtained in the same manner as in Comparative Example 1 except that raw materials including lithium carbonate (Li₂CO₃), ammonium dihydrogen phosphate (NH₄H₂PO₄), calcium oxide (CaO), yttrium oxide (Y₂O₃), and tin dioxide (SnO₂) were weighed so that the composition was such that the formula Li_{1+X}M_{y}(PO₄)₃ satisfying the conditions shown in Table 1 was obtained.

### Comparative Example 4

A solid-state electrolyte powder was obtained in the same manner as in Comparative Example 1 except that raw materials including lithium carbonate (Li₂CO₃), ammonium dihydrogen phosphate (NH₄H₂PO₄), sodium carbonate (Na₂CO₃), and zirconium oxide (ZrO₂) were weighed so that the composition was such that the general formula Li_{1+X}M_{y}(PO₄)₃ satisfying the conditions shown in Table 1 was obtained.

### Example 11

A solid-state electrolyte powder was obtained in the same manner as in Comparative Example 1 except that raw materials including lithium carbonate (Li₂CO₃), ammonium dihydrogen phosphate (NH₄H₂PO₄), sodium carbonate (Na₂CO₃), and zirconium oxide (ZrO₂) were weighed so that the composition was such that the general formula Li_{1+X}M_{y}(PO₄)₃ satisfying the conditions shown in Table 1 was obtained.

(Evaluation of Crystal Structure of Solid-State Electrolyte)

The solid-state electrolyte powders produced in Examples 1 to 11 and Comparative Examples 1 to 4 were measured using an X-ray diffractometer (XRD) at 25° C., a scan rate of 4.0°/min, and a measuring angle range of 10° to 60°, and the crystal structures thereof were evaluated by comparing with the patterns of Joint Committee on Powder Diffraction Standards (JCPDS) Cards. As a result, it was confirmed that the solid-state electrolyte produced in each of the Examples 1 to 11 and Comparative Examples 1 to 4 had a NaSICON-type crystal structure.

(Evaluation of Ionic Conductivity of Solid-State Electrolyte)

The ionic conductivity of the solid-state electrolyte produced in each of the Examples 1 to 11 and Comparative Examples 1 to 4 was measured in the following manner.

A sintered tablet was produced in the following manner. First, a solid-state electrolyte, a butyral resin, and alcohol were mixed at a mass ratio of solid-state electrolyte:butyral resin:alcohol=98:15:140 and then the alcohol was removed on a hot plate at 80° C., thereby obtaining a solid-state electrolyte powder coated with the butyral resin as a binder. Next, the solid-state electrolyte powder coated with the butyral resin was pressed at 90 MPa using a tablet molding machine so as to be molded into a tablet shape. The tablet was sandwiched between two porous setter to produce a sintered body. Specifically, the sintered body was heated to 500° C. in a nitrogen gas atmosphere containing 10% by volume of oxygen to remove the butyral resin, and then the sintered body was fired at a temperature of 1000° C. to 1200° C. in an air atmosphere to obtain a sintered tablet.

Next, the ionic conductivity of the produced sintered tablet was measured. Specifically, a platinum (Pt) layer as a current collector layer was formed on both sides of the sintered tablet by sputtering, the sintered tablet was dried at 100° C. to remove moisture, and sealed with a 2032 type coin cell. The ionic conductivity was calculated by measuring the AC impedance with respect to the sealed cell. The AC impedance was measured using a frequency response analyzer (FRA) (manufactured by Solartron) in the frequency range of 0.1 MHz to 1 MHz with an amplitude of ±10 mV at a temperature of 25° C.

The ionic conductivity σ was calculated from the following equation by determining the resistivity (the sum of the grain resistivity and the grain-boundary resistivity) of each of the solid-state electrolytes from the Cole-Cole plot obtained from the measurement of the AC impedance. Note that the resistivity (the sum of the grain resistivity and the grain-boundary resistivity) of each of the solid-state electrolytes was defined as the value at the right end of the arc in the Cole-Cole plot. The results are shown in Tables 1 to 4.

σ=(t/A)×(1/R)

σ: Ionic conductivity

t: Thickness of sample

A: Area of electrode

R: Resistance of solid-state electrolyte

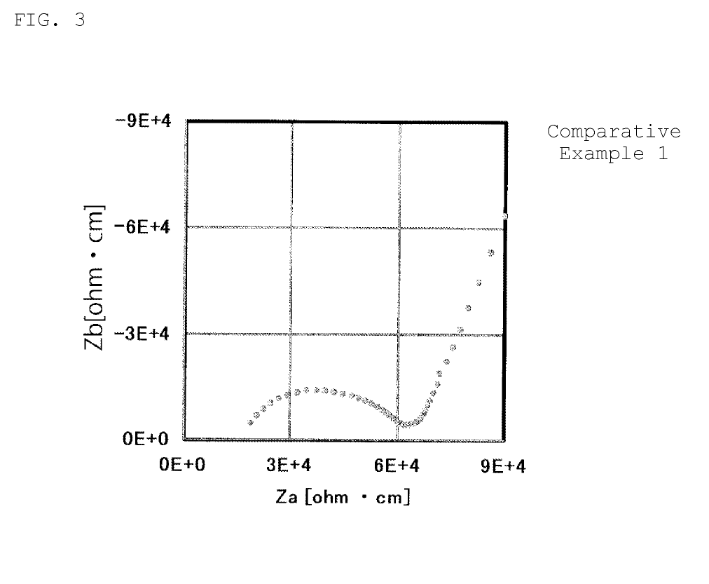

FIG. 2 shows the Cole-Cole plot of the solid-state electrolyte produced in Example 1. FIG. 3 shows the Cole-Cole plot of the solid-state electrolyte produced in Comparative Example 1.

TABLE 1

| | | | | | | Ionic |
|---|---|---|---|---|---|---|
| | M | | | | | conductivity |
| | Ca | Y | Zr | x | y | (×10⁻⁵ S/cm) |
| Comparative | 0.100 | 0.114 | 1.786 | 0.314 | 2.000 | 1.6 |
| Example 1 | | | | | | |
| Example 1 | 0.100 | 0.114 | 1.787 | 0.310 | 2.001 | 16.0 |
| Example 2 | 0.100 | 0.115 | 1.795 | 0.275 | 2.010 | 15.0 |
| Example 3 | 0.100 | 0.116 | 1.814 | 0.196 | 2.030 | 13.0 |
| Example 4 | 0.100 | 0.117 | 1.833 | 0.117 | 2.050 | 12.0 |
| Example 5 | 0.100 | 0.118 | 1.842 | 0.078 | 2.060 | 9.0 |
| Example 6 | 0.100 | 0.119 | 1.871 | −0.041 | 2.090 | 8.0 |
| Example 7 | 0.100 | 0.120 | 1.880 | −0.080 | 2.100 | 7.0 |
| Example 8 | 0.100 | 0.121 | 1.899 | −0.159 | 2.120 | 4.0 |

TABLE 2

| | | | | | | Ionic |
|---|---|---|---|---|---|---|
| | M | | | | | conductivity |
| | Ca | Y | Hf | x | y | (×10⁻⁵ S/cm) |
| Comparative | 0.100 | 0.114 | 1.786 | 0.314 | 2.000 | 1.1 |
| Example 2 | | | | | | |
| Example 9 | 0.110 | 0.114 | 1.786 | 0.294 | 2.010 | 10.0 |

TABLE 3

| | | | | | | Ionic |
|---|---|---|---|---|---|---|
| | M | | | | | conductivity |
| | Ca | Y | Sn | x | y | (×10⁻⁵ S/cm) |
| Comparative | 0.100 | 0.114 | 1.786 | 0.314 | 2.000 | 0.9 |
| Example 3 | | | | | | |
| Example 10 | 0.110 | 0.114 | 1.786 | 0.294 | 2.010 | 10.0 |

TABLE 4

| | | | | | Ionic |
|---|---|---|---|---|---|
| | M | | | | conductivity |
| | Na | Zr | x | y | (×10⁻⁵ S/cm) |
| Comparative Example 4 | 0.050 | 1.950 | 0.150 | 2.000 | 1.4 |
| Example 11 | 0.100 | 1.950 | 0.100 | 2.050 | 15.0 |

The ionic conductivity of the solid-state electrolyte produced in each of the Examples 1 to 8 was 0.4×10⁻⁴ S/cm to 1.6×10⁻⁴ S/cm, both of which were higher than that of the solid-state electrolyte produced in Comparative Example 1.

The ionic conductivity of the solid-state electrolyte produced in Example 9 was 1.0×10⁻⁴ S/cm, which was higher than that of the solid-state electrolyte produced in Comparative Example 2.

The ionic conductivity of the solid-state electrolyte produced in Example 10 was 1.0×10⁻⁴ S/cm, which was higher than that of the solid-state electrolyte produced in Comparative Example 3.

The ionic conductivity of the solid-state electrolyte produced in Example 11 was 1.5×10⁻⁴ S/cm, which was higher than that of the solid-state electrolyte produced in Comparative Example 4.

In particular, it is understood from the results of Examples 1 to 4 and 9 to 11 that higher ionic conductivity can be obtained when y is 2.001 or more and 2.050 or less in the formula Li_{1+X}M_{y}(PO₄)₃.

### DESCRIPTION OF REFERENCE SYMBOLS

1: All-solid-state battery
11: Positive electrode
12: Negative electrode
13: Solid-state electrolyte layer

1. A solid-state electrolyte having a NaSICON-type crystal structure represented by Li_{1+X}M_{y}(PO₄)₃, wherein M includes at least one element selected from a monovalent cation to a tetravalent cation, x is −0.200 to 0.900, and y is 2.001 to 2.200.

2. The solid-state electrolyte according to claim 1, wherein a part of the P is substituted by at least one selected from the group of Si, B, and V.

3. The solid-state electrolyte according to claim 2, wherein y is 2.001 to 2.100.

4. The solid-state electrolyte according to claim 2, wherein y is 2.001 to 2.050.

5. The solid-state electrolyte according to claim 1, wherein y is 2.001 to 2.100.

6. The solid-state electrolyte according to claim 1, wherein y is 2.001 to 2.050.

7. The solid-state electrolyte according to claim 1, wherein M includes at least one element selected from the monovalent cation to a trivalent cation.

8. The solid-state electrolyte according to claim 1, wherein M includes at least one element that is a tetravalent cation.

9. The solid-state electrolyte according to claim 1, wherein M includes at least one element selected from the group of Zr, Hf, Ca, Y, Na, Al, Ga, Sc, V, In, Ti, Ge, and Sn.

10. The solid-state electrolyte according to claim 7, wherein M includes at least one element selected from the group of Na, Ca, Y, Al, Ga, Sc, V, and In.

11. The solid-state electrolyte according to claim 8, wherein M includes at least one element selected from the group of Zr, Hf, Sn, Ti, and Ge.

12. An all-solid-state battery comprising:
a solid-state electrolyte layer which includes the solid-state electrolyte according to claim 1;
a positive electrode joined to a first surface of the solid-state electrolyte layer; and
a negative electrode joined to a second surface of the solid-state electrolyte.

13. The all-solid-state battery according to claim 12, wherein a part of the P is substituted by at least one selected from the group of Si, B, and V.

14. The all-solid-state battery according to claim 13, wherein y is 2.001 to 2.100.

15. The all-solid-state battery according to claim 13, wherein y is 2.001 to 2.050.

16. The all-solid-state battery according to claim 12, wherein y is 2.001 to 2.100.

17. The all-solid-state battery according to claim 12, wherein y is 2.001 to 2.050.

18. The all-solid-state battery according to claim 12, wherein M includes at least one element selected from the monovalent cation to a trivalent cation.

19. The all-solid-state battery according to claim 12, wherein M includes at least one element that is a tetravalent cation.

20. The all-solid-state battery according to claim 12, wherein M includes at least one element selected from the group of Zr, Hf, Ca, Y, Na, Al, Ga, Sc, V, In, Ti, Ge, and Sn.
